(19) United States
(12) Patent Application Publication
(10) Pub. No.: US 2025/0301550 A1
(43) Pub. Date: Sep. 25, 2025

(54) STREETLIGHT LAMP POST, STREET LIGHTING SYSTEM AND METHOD FOR OPERATING A STREET LIGHTING SYSTEM

(71) Applicant: SIGNIFY HOLDING B.V., EINDHOVEN (NL)

(72) Inventors: BARTEL MARINUS VAN DE SLUIS, EINDHOVEN (NL); BERTRAND JOHAN EDWARD HONTELE, BREDA (NL); EUGEN JACOB DE MOL, EINDHOVEN (NL); NORBERTUS ANTONIUS MARIA SWEEGERS, LIEROP (NL)

(21) Appl. No.: 18/863,403

(22) PCT Filed: May 8, 2023
(86) PCT No.: PCT/EP2023/062091

§ 371 Date: Nov. 6, 2024

(30) Foreign Application Priority Data
May 16, 2022 (EP) 22173483.3

(51) Int. Cl. H05B 47/115; F21S 9/03; F21V 21/116; F21W 131/103; H05B 47/11; H05B 47/155; H05B 47/195

(52) U.S. Cl. CPC H05B 47/115; F21S 9/035; F21V 21/116; H05B 47/11; H05B 47/155; H05B 47/195; F21W 2131/103

(57) ABSTRACT

A streetlight lamp post (100) comprising a streetlight (104) mounted on a lamp post (102). The streetlight lamp post further comprises at least one first solar cell (106) arranged at a first side of the lamp post, at least one second solar cell (108) arranged at a second side of the lamp post, and a control unit (212). The control unit is configured to determine an orientation of the at least one first solar cell and the at least one second solar cell with regard to a road (524) and/or approaching vehicles (526) based on light input detected by the at least one first solar cell and the at least one second solar cell. The control unit is further configured to control the streetlight based on light input detected by the first solar cell and/or the second solar cell and the determined orientation of the solar cells.

### TECHNICAL FIELD

The present disclosure relates generally to the field of street lighting. More specifically, it relates to a streetlight lamp post comprising solar cells arranged at different sides of the lamp post, and a street lighting system comprising such lamp posts.

### BACKGROUND

Solar-powered street lighting is a subject of interest across the world. Solar-powered street lighting systems enable building and lighting new roads in areas without an existing power infrastructure, which may be important in developing countries as well as in rural areas of developed countries. Further, as a renewable power source, using solar power for lighting streets may contribute to realizing climate objectives all over the world.

As it stands, typical solar streetlights may comprise conventional street light poles extended with a conventional solar panel, usually arranged on top of the streetlight. Such arrangements may be sensitive to high winds and provide reduced mechanical stability. Further, the arrangements may not be adapted for collecting sunlight during an entire day, or during the year, as the sun moves across the sky. Conventional solar streetlights may also introduce visual clutter.

### SUMMARY

It is therefore an object of the present invention to overcome at least some of the above-mentioned drawbacks, and to provide improved systems and devices for streetlighting making use of the advantages provided by solar panels.

This and other objects are achieved by means of a streetlight lamp post, a street lighting system, and a method for operating a street lighting system defined in the appended independent claims. Other embodiments are defined by the dependent claims.

According to a first aspect, a streetlight lamp post is provided. The streetlight lamp post comprises at least one first solar cell arranged at a first side of the lamp post and at least one second solar cell arranged at a second side of the lamp post. The streetlight lamp post further comprises a control unit. The control unit is configured to determine, based on light input detected by the at least one first solar cell and the at least one second solar cell, an orientation of the at least one first solar cell and the at least one second solar cell with regard to a road and/or approaching vehicles. The control unit is further configured to control a streetlight light output based on light input detected by the first solar cell and/or the second solar cell and the determined orientation of the solar cells.

Arranging the solar cells at the sides of the lamp post may improve solar light harvesting during winter days when the sun is at lower elevation angles. Further, when the solar cells are arranged on the sides of the lamp post, they may be used to detect other light coming from the sides, such as light coming from an approaching vehicle. The first and second solar cells may therefore be suitably arranged to act as light detectors for detecting, e.g., headlights of oncoming traffic.

The control unit of the streetlight lamp post according to the first aspect may analyze light input signals from individual or groups of solar cells (i.e., the at least one first solar cell and the at least one second solar cell) mounted with different orientations at the lamp post (or streetlight pole). From the analysis, road and/or vehicle-oriented cells may be determined. For example, the control unit may determine which solar cells of the at least one first and at least one second solar cells are oriented towards headlights of approaching traffic. When the orientation of the solar cells (e.g., first and second solar cells) has been determined, the light input (power signals) of the solar cells may be used to control the streetlight. For example, the control unit may select a subset of the solar cells, based on their determined orientation, from which light input is to be used for controlling the streetlight.

In order to save energy at quiet times with less traffic, such as in the middle of the night, it may be preferable to activate the streetlight (lamp/luminaire) on demand, for example when approaching vehicles are detected.

According to some embodiments, the control unit may be further configured to detect, from the light input detected by at least one of the first solar cell and the second solar cell, a vehicle approaching the lamp post. The control unit may be further configured to control the streetlight light output based on said detection.

Such embodiments may provide light-on-demand without any additional sensors or cameras. For example, the control unit may turn on or increase the light output of the streetlight based on detection of an approaching vehicle.

According to some embodiments, the control unit may be further configured to determine, from the light input detected by at least one of the at least one first solar cell and the at least one second solar cell, a position of the approaching vehicle. The control unit may further be configured to adapt the streetlight light output based on the position of the approaching vehicle.

The control unit may for example determine an absolute position of the approaching vehicle, or a relative position. For example, the position of the approaching vehicle may be determined or estimated based on a signal strength of the detected light input. Further, depending on which solar cells are detecting light from the vehicle, an orientation of the vehicle relative to the lamp post may be determined.

According to some embodiments, the control unit may be further configured to operate in a calibration mode and in an operation mode.

In the calibration mode, the control unit may be configured to control a light output of the streetlight and monitor light input detected by the at least one first solar cell and the at least one second solar cell. Based on the monitored light input, the control unit may further be configured to determine an orientation of the first solar cell and the second solar cell relative to the streetlight. For example, when controlling the light output of the streetlight, light input at the at least one first solar cell and the at least one second solar cell may be monitored for a shorter time, such as in the range of seconds or milliseconds.

In the calibration mode, the control unit may, additionally or alternatively, be further configured to monitor light input detected by the at least one first solar cell and the at least one second solar cell over a period of time. The period of time may, for example, be in the range of minutes, hours, or days. The control unit may further be configured to detect, in the monitored light input, a pattern corresponding to an approaching vehicle. Based on the detected pattern, the control unit may be configured to determine an orientation of the first solar cell and the second solar cell relative to the approaching vehicle.

In the operation mode, the control unit may be configured to control the streetlight based on light input detected by the at least one first solar cell and/or the at least one second solar cell and the determined orientation of the solar cells.

After installing and starting up the streetlight lamp post for the first time, the control unit may automatically enter the calibration phase/mode. Alternatively, the calibration phase or mode may be activated by an operator. The calibration mode may preferably be activated at nighttime, such that the calibration is not affected by surrounding daylight.

In the calibration mode, the control unit may determine an orientation of the cells or cell groups with regard to the road, the streetlight and/or approaching vehicles in order to select cells most suitable to detect traffic. For example, the control unit may determine on which side the streetlight is located and which cells detect headlight patterns.

In the calibration mode, the streetlight may be controlled by the control unit. An orientation of the solar cells relative to the streetlight may be determined based on light input detected by the solar cells when the streetlight is activated. For instance, the signals from each solar cell, or solar cell group, may be compared at the moment that the streetlight is activated to determine which cells are placed at the side of the streetlight luminaire. The control unit may determine the road-oriented cells based on the cells which most prominently detect the activated streetlight output.

In a similar way, the light patterns of approaching vehicle headlights may be detected most prominently by solar cells or solar cell groups oriented towards the approaching vehicle. In the calibration mode, the control unit may determine cells most suitable for detecting oncoming traffic (approaching vehicles) by monitoring the detected light input of the solar cells (or solar cell group) over a period of time and detecting patterns in the detected light input corresponding to an approaching vehicle (e.g., headlight patterns).

After the calibration mode/stage, the street lighting system may switch to an operational traffic sensing mode (operation mode). In the operation mode, the control unit may control the streetlight based on light input detected by the solar cells or solar cell groups (i.e., the at least one first and the at least one second solar cell).

In the traffic sensing/operation mode, the streetlight may be activated upon detection of approaching vehicle lights by the selected/determined road/vehicle-oriented cell groups. Optionally, approaching vehicles can be detected at multiple sides using different solar cells/cell groups. The control unit may activate different light outputs of the streetlight, e.g., by varying light output intensity or distribution, depending on a position and direction of the approaching vehicle. At the same time, at least some, or all, solar cells may be used to provide power to, e.g., the streetlight, or other devices/units within the streetlight lamp post.

Optionally, the operation mode may be active only at nighttime. For instance, the general level of solar cell signals can be used to determine that it has become dark, which may activate the traffic sensing mode.

According to some embodiments, the control unit may further be configured to detect, from the light input detected by the at least one first and the at least one second solar cell, a surrounding daylight property. The control unit may further be configured to control the streetlight based on the surrounding daylight property.

Such embodiments may allow for the streetlight to be turned off when there is sufficient daylight, which in turn may decrease energy consumption. For example, the control unit may activate or deactivate the streetlight based on an average or general light level detected at the solar cells.

According to some embodiments, the control unit may further be configured to receive information relating to a current light output of the streetlight. The control unit may further be configured to compensate the light input detected by the at least one first solar cell and the at least one second solar cell based on the known current light output of the streetlight and the determined orientation of the solar cells.

The streetlight light output may affect the light input detected at the first and second solar cell(s). Therefore, the control unit may compensate the detected light input based on the known current light output of the streetlight itself. The present light output may be known to the control unit. Alternatively, the light output may be measured by the control unit.

According to some embodiments, the at least one first solar cell may comprise a plurality of first solar cells arranged in a vertical row. The at least one second solar cell may comprise a plurality of second solar cells arranged in a vertical row.

The plurality of first solar cells may be arranged in a first vertical row on the first side of the lamp post. The plurality of second solar cells may be arranged in a second vertical row on the second side of the lamp post. Arranging several solar cells in a vertical row may allow for receiving light at different heights of the lamp post.

In order to optimize solar energy harvesting, several vertical cell rows may be placed in parallel around at least a portion of the lamp post. This may provide a larger solar cell area for collecting light, potentially in different directions. Further, the vertical cell rows may allow detection of a variation in light input detected at the different cell rows. Determining a variation in light input from different vertical cell rows, or from individual cells or cell groups positioned at different horizontal positions, may facilitate determining a direction from which light is received, such as for determining the position of an approaching vehicle.

According to some embodiments, the at least one first solar cell and the at least one second solar cell may form part of a cylindrical or angular solar cell array wrapping around at least a part of the lamp post.

For example, an angular solar cell array may have a hexagonal, octagonal, decagonal, or similar, cross section. Cylindrical or angular solar cell arrays wrapping around at least a part of the lamp post may not require any orientation of the solar panel towards the typical sun position, which may simplify installation. Further, arranging the solar cells wrapping around at least a portion of the lamp post may improve sunlight harvesting as the sun moves across the sky, especially during winter days when the sun is at lower elevation angles, or during cloudy conditions when the solar cells may capture diffuse light from several different directions.

The solar cells may for example be mounted on or integrated with the (e.g., cylindrical) streetlight pole. Solar cells arranged close to the lamp post, or integrated in the lamp post, may provide less visual clutter, and may therefore minimize distractions for drivers.

According to some embodiments, the at least one first solar cell and the at least one second solar cell may form part of a flexible solar cell foil.

Thin-film flexible solar cells may be robust and compact. They may also be easily integrated into the lamp post. The flexible solar cell foil may at least partially wrap around the lamp post.

According to some embodiments, the streetlight lamp post may further comprise a battery. The battery may be configured to be charged by the at least one first solar cell and the at least one second solar cell. The battery may be configured to provide power to the streetlight.

The solar cells (i.e., the at least one first solar cell and the at least one second solar cell) may serve the double purpose of charging the battery of the streetlight lamp post when there is sufficient surrounding daylight and acting as light sensors.

According to some embodiments, the streetlight lamp post may further comprise a communication module. The control unit may further be configured to transmit information relating to light input received from the at least one first solar cell and said at least one second solar cell to another streetlight lamp post using said communication module.

For example, the control unit may transmit information relating to an approaching vehicle or a detected surrounding daylight. Further, the control unit may transmit information relating to a current light output of the streetlight to another streetlight lamp post. The communication module may for example use modulated visible light communication or radio frequency (RF) communication.

According to some embodiment, the control unit may be further configured to receive, via said communication module, information from another streetlight lamp post, and to control the streetlight based on said received information.

Communication between lamp posts (light poles) may improve the overall performance by activating streetlights on time based on an approaching vehicle detected by a different lamp post, or by determining direction and speed of vehicles based on, e.g., times of detection of a vehicle at different lamp posts.

For example, if the control unit may receive information relating to an approaching vehicle, the control unit may control a light output of the streetlight based on this information. For example, the control unit may activate the streetlight, or increase a light output of the streetlight, based on the received information.

Further, information received from another streetlight lamp post may be used for fault detection. For example, if information is received from another streetlight lamp post indicating that there is sufficient surrounding daylight, while the light input of the solar cells of the present streetlight lamp post indicate that it is dark, this can be a suggestion that there is a fault somewhere in the system, that there is dirt on the solar cells etc.

According to a second aspect, a street lighting system is provided. The street lighting system comprises at least two streetlight lamp posts in accordance with the first aspect of this disclosure, each comprising a communication module. The at least two streetlight lamp posts are configured to communicate with each other using said communication modules.

The streetlight lamp posts of the system may communicate to, for example, provide a better experience for a driver by adapting an output light to presence or position of the vehicle. For example, information of the vehicle may be communicated to street light lamp posts further ahead, which may adjust their light output in time before the vehicle arrives.

According to some embodiments, a control unit in a first streetlight lamp post of the system (i.e., a first control unit) may be configured to detect, based on light input detected by the at least one first and/or the at least one second solar cell of the first streetlight lamp post, a vehicle approaching the first street light lamp post. The first control unit may further be configured to control the streetlight of the first streetlight lamp post based on the detection of the vehicle. The first control unit may further be configured to communicate information relating to said detection of the vehicle, using the communication module of the first streetlight lamp post, to a second streetlight lamp post of the system. A control unit of the second streetlight lamp post (i.e., a second control unit) may be configured to receive the information relating to the detection of the vehicle from the first streetlight lamp post, using the communication module of the second streetlight lamp post. The second control unit may further be configured to control the streetlight of the second streetlight lamp post based on the received information.

In such embodiments, a number of streetlights ahead of the streetlight which detects the vehicle may be activated before light of the headlights of the vehicle reach their lamp posts. The light output of the streetlights may be adapted based on a distance between the lamp post and the oncoming vehicle.

According to a third aspect of the present disclosure, a method for operating a street lighting system in accordance with the second aspect of the disclosure is provided. The method comprises performing a calibration stage comprising controlling a light output of each of the streetlight lamp posts in the system. The calibration stage further comprises monitoring light input detected by the at least one first solar cell and the at least one second solar cell of each of the streetlight lamp posts during the controlling the light output of each of the streetlight lamp posts. The calibration stage further comprises, based on the monitored light input, determining an orientation and/or position of each streetlight lamp post in relation to the other streetlight lamp posts of the street lighting system. The method further comprises operating the streetlights of the street lighting system based on light input detected by the solar cells of the streetlight lamp posts and the determined orientation and/or position of each of the streetlight lamp posts.

As for the single street light lamp post described above with reference to the first aspect of the disclosure, the calibration stage may be automatically started upon installation and initial upstart of the streetlighting system. Alternatively, the calibration stage may be initiated by a local or remote operator.

When operating the streetlight lamp posts, the control unit of a lamp post may, due to the calibration stage, recognize light emitted by other streetlights in the same street lighting system.

To improve legibility of this disclosure, features which are similar or equivalent between the first, second and third aspects of the disclosure may only be repeated for one or two of the aspects. The person skilled in the art realises that advantages or further details provided for features of one of the aspects may be applicable for similar/equivalent features of the other aspects.

It is noted that other embodiments using all possible combinations of features recited in the above-described embodiments may be envisaged. Thus, the present disclosure also relates to all possible combinations of features mentioned herein.

### BRIEF DESCRIPTION OF DRAWINGS

Exemplifying embodiments will now be described in more detail, with reference to the following appended drawings:

FIG. 1 is an illustration of a streetlight lamp post, in accordance with some embodiments;

FIG. 2 is a schematic block diagram of a streetlight lamp post in accordance with some embodiments;

FIG. 3 is an illustration of an angular solar panel which may be used in a streetlight lamp post in accordance with some embodiments;

FIG. 4 is an illustration of a cylindrical solar panel which may be used in a streetlight lamp post in accordance with some embodiments; and

FIG. 5 is an illustration of a street lighting system, in accordance with some embodiments.

As illustrated in the figures, the sizes of the elements and regions may be exaggerated for illustrative purposes and, thus, are provided to illustrate the general structures of the embodiments. Like reference numerals refer to like elements throughout.

### DETAILED DESCRIPTION

Exemplifying embodiments will now be described more fully hereinafter with reference to the accompanying drawings in which currently preferred embodiments are shown. The invention may, however, be embodied in many different forms and should not be construed as limited to the embodiments set forth herein; rather, these embodiments are provided for thoroughness and completeness, and fully convey the scope of the invention to the skilled person.

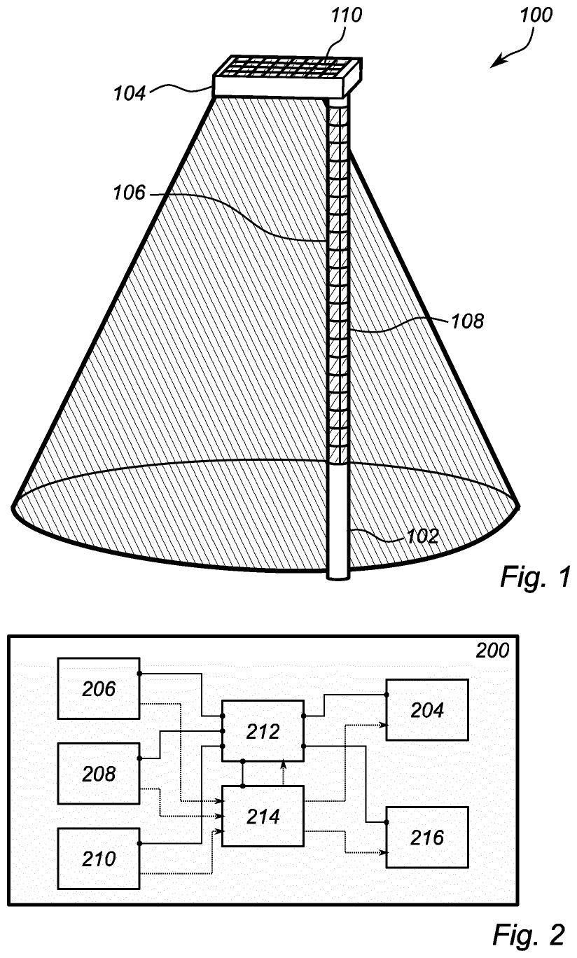

With reference to FIGS. 1 and 2, a streetlight lamp post 100, in accordance with some embodiments, will be described.

FIG. 1 schematically shows a streetlight lamp post 100. The street light lamp post 100 comprises a streetlight 104 mounted on a lamp post 102. The streetlight lamp post 100 further comprises a plurality of first solar cells 106 arranged in a first vertical array on a first side of the lamp post 102. A second vertical array of second solar cells 108 is arranged on a second side of the lamp post 102. The streetlight lamp post 100 further comprises an array of additional solar cells, in the form of an additional solar panel 110 arranged on top of the streetlight 104. The vertical arrangement of the first solar cells 106 and the second solar cells 108 allow them to collect light coming from a side of the lamp post 102. Thus, the first and second solar cells 106, 108 may capture light from, e.g., a rising or setting sun, or from approaching vehicles. The first and second solar cells 106, 108 may therefore act as light detectors. The additional solar panel 110 is arranged on top of the streetlight 104, it is therefore suitable for collecting light coming from above the streetlight lamp post 100. The additional solar panel 110 may therefore be used mainly to provide power to the streetlight 104 and other devices within the streetlight lamp post 100.

FIG. 2 is a block diagram illustrating a streetlight lamp post 200. It should be noted that FIG. 2 comprises features, elements and/or functions as shown in FIG. 1 and described in the associated text. The features are identified by reference numbers made up of the number of the figure to which it relates followed by the number of the feature, which are equivalents for all exemplifying embodiments, e.g., the common feature “10” is indicated by “110” in FIG. 1 while the corresponding feature is indicated by “210” in FIG. 2. Hence, it is also referred to FIG. 1 and the description relating thereto for an increased understanding.

In addition to the streetlight 204, the at least one first solar cell 206, the at least one second solar cell 208, and the additional solar panel 210, described above with reference to FIG. 1, the streetlight 204 also comprises a control unit 212. The control unit 212 is in connection with the first and second solar cells 206, 208, the streetlight 204 and the additional solar panel 210. The control unit is further in connection with a battery 214 and a communication module 216.

The at least one first and second solar cell 206, 208 are arranged to provide signals corresponding to a light input detected at the solar cell 206, 208 to the control unit 212. The first and second solar cell 206, 208 may further be arranged to provide power for charging the battery 214, and/or to provide power directly to the streetlight 204, control unit 212 and/or the communication module 216, although no such direct connection is illustrated in FIG. 2.

The solar panel 210 may also provide signals corresponding to a light input detected at the solar panel 210 to the control unit 212. The solar panel 210 may provide power for charging the battery 214, and/or to provide power directly to the streetlight 204, control unit 212 and/or the communication module 216, although no such direct connection is illustrated in FIG. 2.

The battery 214 may be configured to provide power to the streetlight 204. The battery 214 may also provide power to the communication module 216 and/or the control unit 212.

The control unit 212 is configured to receive (signals corresponding to) light input detected by the first and second solar cells 206, 208, and determine an orientation of the first and second solar cells 206, 208 with regard to a road and/or approaching vehicles, based on the received light input.

For example, in FIG. 1, the first solar cells 106 are arranged on the same side as the streetlight 104, while the second solar cells 108 are arranged on the opposite side of the lamp post 102. The first solar cells 106 may therefore detect more light emitted by the streetlight 104 than the second solar cells 108. Normally, a streetlight lamp post 100 is arranged with the streetlight 104 facing the road. The control unit 212 may therefore determine, based on signals relating to the light input received from the first solar cells 106 being higher than the light input received from the second solar cells 108/208, that the first solar cells 106 are arranged facing the road, while the second solar cells 108 are not facing the road. The control unit 212 may therefore select the first solar cell array 106 as being more suitable for detecting approaching vehicles than the second solar cell array 108.

The control unit 212 is further configured to control the streetlight 204. Specifically, the control unit 212 may be configured to control an output light, such as an intensity or distribution of output light, of the streetlight 204. Further, the control unit 212 may control the streetlight 204 based on light input detected by the first solar cell 206 and/or the second solar cell 208 and the determined orientation of the solar cells. For example, in the embodiment illustrated in FIG. 1, the control unit 212 may detect an oncoming vehicle mainly from the input light detected by the array of first solar cells 106, which faces the road.

The control unit 212 may further be configured to communicate with other street light lamp posts via the communication module 216. Specifically, the control unit 212 may transmit signals/information to other street light lamp posts and/or receive signals/information from other street light lamp posts. Such communication may for example take place in a streetlighting system which will be described in further detail below with reference to FIG. 5.

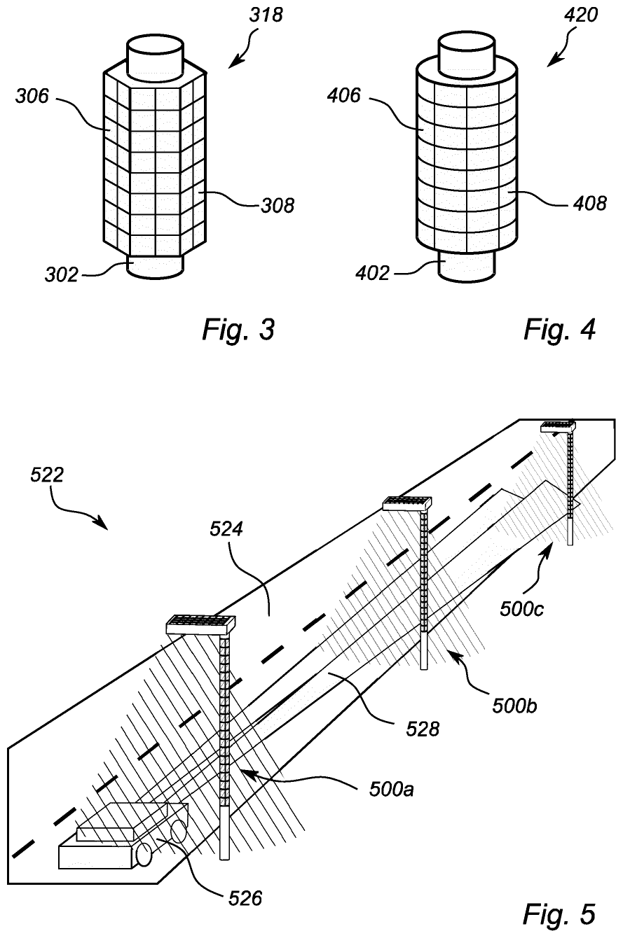

While the streetlight lamp post of the present disclosure may be realized using a single first and a single second solar cell, arranged on different sides of the lamp post, the first and second solar cells may form part of a larger array. With reference to FIGS. 3 and 4, examples of solar cell arrays which may be used in streetlight lamp post of the present disclosure will be described.

FIG. 3 is an illustration of an angular solar array 318 arranged on a lamp post 302. The angular solar array 318 has a generally hexagonal cross section. The angular solar array 318 comprises a plurality of vertical solar cell arrays/rows arranged in parallel. The at least one first solar cell 306 forms part of one of the vertical arrays/rows on one side of the lamp post 302. The at least one second solar cell forms part of another vertical array/row on a second side of the lamp post 302. The angular solar array 318 wraps around the lamp post 302, such that light may be collected or detected all around the lamp post 302.

FIG. 4 is an illustration of a cylindrical solar array 420 arranged on a lamp post 402. The cylindrical solar array 420 also comprises a plurality of vertical solar cell arrays, wrapping around the lamp post 402. One of the vertical arrays comprises the at least one first solar cell 406, another vertical array comprises the at least one second solar cell 408.

With reference to FIG. 5, a street lighting system 522 in accordance with some embodiments will be described.

The street lighting system 522 comprises a plurality of streetlight lamp posts 500a-c, three of which are illustrated in FIG. 5. The streetlight lamp posts 500a-c are equivalent to the streetlight lamp posts 100, 200 described above with reference to FIGS. 1 and 2. Below, reference is also made to features illustrated in more detail in FIGS. 1 and 2. For a clearer image, the illustrated streetlight lamp posts 500a-c are all arranged on the same side of a road 524. It will however be appreciated that similar street lighting systems 522 may comprise streetlight lamp posts arranged along both sides of a road 524.

The streetlight lamp posts 500a-c all comprise a communication module 216, as described above with reference to FIG. 2, in order to communicate with one another. The control unit 212 of each of the streetlight lamp posts 500a-c is configured to adapt a light output of its related streetlight 104 based on detected light input from its solar cells 106, 108, and on communication (information/signals) received from the other streetlight lamp posts 500a-c.

In a calibration phase, the street lighting system 522 may be calibrated to, e.g., determine relative positions and orientations of the streetlight lamp posts 500a-c of the system, to detect vehicles 526 driving along the road 524, and to compensate for light originating from the street lighting system 522 itself.

During the calibration phase, a light output of each of the streetlights 104 of the street lighting system 522 may be controlled. For example, the streetlights 104 may be turned on and off one at a time. A light input detected by the solar cells 106, 108 of each streetlight lamp post 500a-c may be monitored during the controlling of the streetlights 104, such that each control unit 212 may recognize light input originating from its own streetlight 104 and from the other streetlight lamp posts 500a-c. Further, each of the control units 212 may determine an orientation of its solar cells relative to its own streetlight 104 and the other streetlight lamp posts 500a-c.

Further, in the calibration phase, the light input of the solar cells 106, 108 of each of the streetlight lamp posts 500a-c may be monitored over a period of time. During this period of time, one or more vehicles 526, with their headlights 528 on, may be driven along the road 524. The headlights 528 may illuminate the solar cells 106, 108 of the streetlight lamp posts 500a-c in distinctive patterns. During the period of time, the control units 212 may be calibrated to recognize such patterns in light input detected at the solar cells 106, 108.

In an operating phase, the streetlights 104 of the system 522 may be operated based on light input detected by the solar cells 106, 108 of the streetlight lamp posts 500a-c and the determined orientation and/or position of each of the streetlight lamp posts 500a-c. When a vehicle 526 drives along the road 524, its headlights 528 may first illuminate a first street light lamp post 500a. When the first street light lamp post 500a detects the illumination from the headlights 528, it may increase the light output of its streetlight 104. The first streetlight lamp post 500a may further communicate to the other streetlight lamp posts 500b-c, further down the road 524, that a vehicle 526 is approaching. The other streetlight lamp posts 500b-c may then increase a light output of their streetlights 104 before the vehicle 526 arrives. An intensity and/or distribution of the light output of a streetlight lamp post 500a-c may be based on a distance from the streetlight lamp post 500a-c to the vehicle 526.

A position of the vehicle 526 with regard to the streetlight lamp posts 500a-c of the system 522 may be determined based on which solar cells 106, 108 are illuminated by the headlights 528, and on how the intensity of light varies between the solar cells 106, 108.

The person skilled in the art realizes that the present invention by no means is limited to the preferred embodiments described above. On the contrary, many modifications and variations are possible within the scope of the appended claims.

Although features and elements are described above in particular combinations, each feature or element can be used alone without the other features and elements or in various combinations with or without other features and elements.

Additionally, variations to the disclosed embodiments can be understood and effected by the skilled person in practicing the claimed invention, from a study of the drawings, the disclosure, and the appended claims. In the claims, the word “comprising” does not exclude other elements, and the indefinite article “a” or “an” does not exclude a plurality. The mere fact that certain features are recited in mutually different dependent claims does not indicate that a combination of these features cannot be used to advantage.

1. A streetlight lamp post comprising:
a streetlight mounted on a lamp post;
at least one first solar cell arranged at a first side of the lamp post;
at least one second solar cell arranged at a second side of the lamp post; and
a control unit configured to:
determine, based on light input detected by the at least one first solar cell and the at least one second solar cell, an orientation of the at least one first solar cell and the at least one second solar cell with regard to a road and/or approaching vehicles; and
control a streetlight light output based on light input detected by the first solar cell and/or the second solar cell and the determined orientation of the solar cells.

2. The streetlight lamp post of claim 1, wherein said control unit is further configured to:
detect, from the light input detected by at least one of the first solar cell and the second solar cell, a vehicle approaching the lamp post; and
control the streetlight light output based on said detection.

3. The streetlight lamp post of claim 2, wherein said control unit is further configured to:
determine, from the light input detected by at least one of the at least one first solar cell and the at least one second solar cell, a position of the approaching vehicle; and
adapt the streetlight light output based on the position of the approaching vehicle.

4. The streetlight lamp post of claim 1, wherein said control unit is configured to operate in a calibration mode and in an operation mode; wherein
in said calibration mode, the control unit is configured to:
control a light output of the streetlight, monitor light input detected by the at least one first solar cell and the at least one second solar cell, and, based on the monitored light input, determine an orientation of the first solar cell and the second solar cell relative to the streetlight; and/or
monitor light input detected by the at least one first solar cell and the at least one second solar cell over a period of time, detect patterns in the monitored light input corresponding to an approaching vehicle, and determine an orientation of the first solar cell and the second solar cell relative to the approaching vehicle; and
in said operation mode, the control unit is configured to control the streetlight based on light input detected by the at least one first solar cell and/or the at least one second solar cell and the determined orientation of the solar cells.

5. The streetlight lamp post of claim 1, wherein said control unit is further configured to:
detect, from the light input detected by the at least one first and the at least one second solar cell, a surrounding daylight property; and
control the streetlight based on the surrounding daylight property.

6. The streetlight lamp post of claim 1, wherein said control unit is further configured to:
receive information relating to a current light output of the streetlight; and
compensate the light input detected by the at least one first solar cell and the at least one second solar cell based on the known current light output of the streetlight and the determined orientation of the solar cells.

7. The streetlight lamp post of claim 1, wherein said at least one first solar cell comprises a plurality of first solar cells arranged in a vertical row, and wherein said at least one second solar cell comprises a plurality of second solar cells arranged in a vertical row.

8. The street light lamp post of claim 1, wherein said at least one first solar cell and said at least one second solar cell form part of a cylindrical or angular solar cell array wrapping around at least a part of the lamp post.

9. The streetlight lamp post of claim 1, wherein said at least one first solar cell and said at least one second solar cell form part of a flexible solar cell foil.

10. The streetlight lamp post of claim 1, further comprising a battery configured to be charged by said at least one first solar cell and said at least one second solar cell, and to provide power to said streetlight.

11. The streetlight lamp post of claim 1, further comprising a communication module, wherein the control unit is further configured to transmit information relating to light input received from the at least one first solar cell and said at least one second solar cell to another streetlight lamp post using said communication module.

12. The streetlight lamp post of claim 11, wherein the control unit is further configured to receive, via said communication module, information from another streetlight lamp post, and to control the streetlight based on said received information.

13. A street lighting system comprising at least two streetlight lamp posts in accordance with claim 11, wherein the at least two streetlight lamp posts are configured to communicate with each other using said communication modules.

14. The street lighting system of claim 13, wherein:
a control unit in a first streetlight lamp post of the system is configured to:
detect, based on light input detected by the at least one first and/or the at least one second solar cell of the first streetlight lamp post, a vehicle approaching the first street light lamp post;
control the streetlight of the first streetlight lamp post based on said detection of the vehicle; and
communicate information relating to said detection of the vehicle, using the communication module, to a second streetlight lamp post of the system; and wherein
a control unit of the second streetlight lamp post is configured to:
receive said information relating to said detection of the vehicle from the first streetlight lamp post, using the communication module; and
control the streetlight of the second streetlight lamp post based on the received information.

15. A method for operating a street lighting system in accordance with claim 13, the method comprising:
performing a calibration stage comprising:
controlling a light output of each of the streetlight lamp posts in the system;
monitoring light input detected by the at least one first solar cell and the at least one second solar cell of each of the streetlight lamp posts during said controlling the light output of each of the streetlight lamp posts; and
based on the monitored light input, determining an orientation and/or position of each streetlight lamp post in relation to the other streetlight lamp posts of the street lighting system; and
operating the streetlights of the street lighting system based on light input detected by the solar cells of the streetlight lamp posts and the determined orientation and/or position of each of the streetlight lamp posts.
